(19) United States
(12) Patent Application Publication
(10) Pub. No.: US 2026/0079552 A1
(43) Pub. Date: Mar. 19, 2026

(54) BATTERY SYSTEM FOR WEARABLE ELECTRONIC DEVICES

(71) Applicant: Raven Resonance Inc., San Francisco, CA (US)

(72) Inventors: Ivan France, Saratoga, CA (US); Curtis Aumiller, San Jose, CA (US); Thomas Suarez, San Francisco, CA (US)

(73) Assignee: Raven Resonance Inc., San Francisco, CA (US)

(21) Appl. No.: 19/325,207

(22) Filed: Sep. 10, 2025

Related U.S. Application Data
(60) Provisional application No. 63/694,486, filed on Sep. 13, 2024.

(51) Int. Cl. G06F 1/26; G02C 5/00; G02C 11/00; G06F 1/16; H01M 10/42; H01M 50/247; H01M 50/264

(52) U.S. Cl. CPC G06F 1/263; G02C 5/001; G02C 11/10; G06F 1/163; G06F 1/1635; H01M 10/4257; H01M 50/247; H01M 50/264; G02C 2200/02; H01M 2010/4278; H01M 2220/30

(57) ABSTRACT

A power supply and management system used in handheld and wearable electronic devices. The system provides one or more batteries that are selectively removable from the device in a manner where the device is continuously powered and/or usable, including during recharging, replacement, or swapping of one or more of the batteries. The device either has multiple receptacles for multiple batteries, which allows batteries to be alternately removed and replaced while the remaining battery continues to provide power, or may include an on-board power storage apparatus that allows for short-term removal of all batteries while maintaining power and operation. In addition, power management of the system allows for selective use or depletion of multiple batteries to achieve uniform depletion, avoiding over-cycling of a single battery, transferring charge between batteries, and reserving charge in one battery until the other is fully depleted—all designed to maintain reliable power and operation.

### RELATED APPLICATIONS

This patent application relates to and claims priority from U.S. Provisional Patent Application No. 63/694,486 entitled “Battery System for Wearable Electronic Devices” filed Sep. 13, 2024 and is incorporated herein by reference including its specification.

### FIELD OF THE INVENTION

The present invention is directed to a system for handheld or wearable devices, such as smart phones or smart glasses for use with computing and similar devices. The inventive system for such devices preferably include one or more detachable batteries. The batteries are most preferably physically connected to the devices either by magnets or some other mechanical locking mechanism. Through such physical connection, the batteries are electrically connected to the internal circuitry of the wearable devices via induction or exposed pins—such as pogo or spring-loaded pins.

### BACKGROUND OF THE INVENTION

Wearable electronic devices, such as smart glasses, have become much more common in recent years. The need for powering such devices is paramount, particularly continuously powering such devices without interruption. In addition, users want to continue to use such devices without interruption, such as to connect to a recharging source.

Under current technology, users must remove wearable devices in order to re-charge them. In addition, if a user wants to replace a battery on such a wearable device, the device typically needs to be shut-down or restarted, because the power is completely disconnected.

Accordingly, there is a need for an improved battery system for wearable electronic devices that allows for continuous, uninterrupted use, and also allows for replacement of batteries without interrupting operation of the wearable device. The present invention fulfills these needs and provides other related advantages.

### SUMMARY OF THE INVENTION

The present invention has been developed in response to the present state of the art, and in particular, in response to the problems and needs in the continuous, uninterrupted use and operation of wearable electronic devices. Such invention relates to a system and configuration of batteries that allow for replacement of “hot-swapping” of one or more batteries while the electronic device is in continuous use or operation. In particular, for smart glasses or similar electronic devices, a system of batteries and power management that allow for replacing a depleted (or nearly depleted) battery with a fully charged battery without interruption of operation or even use, i.e., while wearing the smart glasses.

Each battery can be located anywhere on the device. In the case of smart glasses, two batteries may be attached to the stems or arms of the glasses, i.e., behind the ear, one on each stem. Such attachment may be either mechanically or magnetically. Each battery can be added or removed by a user at-will and in a “hot-swappable” fashion, meaning the device can keep itself powered on even when the battery is disconnected. This “hot-swappable” feature may be achieved by only disconnecting one battery at a time, such that at least one battery is supplying power to the wearable device. Alternatively, the “hot-swappable” feature may be achieved by integrating a capacitor of similar electronic component to store a brief charge that is sufficient to power the device when a battery is removed for a brief time, as during replacement.

For example, a power management circuit (PMC) may contain a small internal battery or capacitor that may be invisible to the exterior of the wearable device. When one external battery is removed, the PMC may choose to switch the device's power source to another available battery - either another external battery or a small internal power source. The small internal power source, i.e., battery or capacitor, may be used by the PMC to keep the wearable device powered long enough to make the switch and otherwise stabilize electrical current during operation. If there are no other batteries connected to the wearable device, or all other batteries do not have enough remaining charge to be used, the PMC may use the small internal battery or capacitor to keep the device powered as the user removes the battery and replaces it with another battery.

The small internal battery or capacitor may be present in both arms or in compartments behind the ears or may be located anywhere else in the smart glasses. Depending on the particular configuration, one stem or arm may contain the circuits that control the external battery operation of both arms. In the reference implementation, the PMC is preferably included on the wearable device's logic board, next to a main processor.

The present invention is directed generally to a battery system for a personal computing device configured to maintain operation of the computing device during battery usage and replacement. Generally, the device may include a body or housing configured to be worn or held by a user. Computing circuitry is preferably disposed within the body or housing. At least one battery receptacle in the body or housing is configured to receive a detachable battery. A power management circuit (PMC) is electrically connected to the computing circuitry and a backup power source is electrically connected to the PMC. The backup power source is configured to provide temporary power to the computing circuitry when no detachable battery is connected to the battery receptacle. Electrical connections in the receptacle are provided for electrically connecting a detachable battery positioned in the battery receptacle to the PMC, the personal computing device is configured to remain powered and operational during removal and replacement of the detachable battery from the battery receptacle.

In one preferred embodiment, a device housing is configured to be worn or held by a user. Computing circuitry is disposed within the device housing. At least one battery receptacle is included on the device housing and the at least one battery receptacle has electrical contacts configured for connection to a detachable battery. A power management circuit (PMC) in the device housing is electrically connected to the computing circuitry and the electrical contacts in the at least one battery receptacle.

A backup power source is included in the device housing and electrically connected to the PMC. The backup power source is configured to temporarily provide power to the computing circuitry when no detachable battery is connected to the electrical contacts in the at least one battery receptacle. The backup power source is also configured to maintain the computing circuitry of the personal computing device powered and operational during removal and replacement of the detachable battery from the at least one battery receptacle.

The at least one battery receptacle may comprise multiple battery receptacles, namely, at least a first battery receptacle and a second battery receptacle. The first battery receptacle being configured to receive a first detachable battery and the second battery receptacle being configured to receive a second detachable battery. The PMC is preferably configured to selectively draw power from the first detachable battery and the second detachable battery based on relative battery condition of each. The PMC is preferably programmed to draw power from both the first detachable battery and the second detachable battery alternately so as to deplete both uniformly. The PMC may also be configured to prevent depleting one of the first detachable battery or the second detachable battery below a predetermined threshold until available power from another detachable battery is substantially depleted. The PMC may also be configured to transfer charge from the first detachable battery to the second detachable battery when a charge level of the second detachable battery falls below a predetermined threshold.

Each of the first detachable battery and the second detachable battery may include a printed circuit board (PCB) with a microcontroller and a fuel gauge integrated circuit that tracks battery cycles and communicates battery condition to the PMC. The fuel gauge integrated circuit preferably saves cycle data to EEPROM memory and provides recommendations for battery usage patterns.

The backup power source may comprise a capacitor configured to maintain power to the computing circuitry for a duration sufficient to complete replacement of a detachable battery. The electrical contacts in the at least one battery receptacle may comprise a magnetic coupling for physical connection and at least one of inductive couplings or spring-loaded conductive pins for electrical connection. The PMC may also comprise at least one of a field programmable gate array (FPGA) or a microcontroller containing firmware configured to manage power distribution from one or more detachable batteries.

In another embodiment, a wearable electronic device is contemplated, the device comprising a housing or a frame configured to be worn by a user. The frame may comprise glasses, such as smart glasses, including a pair of temples extending from the frame. Computing circuitry is disposed within the housing or frame. First and second battery receptacles are included on the housing or frame, each receptacle configured to receive a respective detachable battery and, in the case of a frame with temples, being disposed on a respective one of the temples. A power management circuit (PMC) is electrically connected to the computing circuitry and configured to receive power from detachable batteries positioned in the battery receptacles. Magnetic or mechanical attachments are provided for securing detachable batteries to the first and second battery receptacles. In addition, electrical connections comprising at least one of inductive coupling or conductive pins are provided for electrically connecting detachable batteries to the PMC. The wearable electronic device is preferably configured to remain powered and operational when one detachable battery is removed while another detachable battery remains connected.

In yet another embodiment, a wearable electronic device battery system is contemplated. The system has a device housing configured to be worn on a user's body and includes computing circuitry disposed within the device housing. A first battery receptacle and a second battery receptacle are both disposed on the device housing, with each of the first and second battery receptacles having electrical contacts configured for connection to a first detachable battery and a second detachable battery respectively. A power management circuit (PMC) is electrically connected to the computing circuitry and configured to receive power from one of the first or second detachable batteries when the same are connected to the first or second battery receptacles.

Magnetic or mechanical connectors in the first battery receptacle and the second battery receptacle are provided for securing the first detachable battery and the second detachable battery respectively. In addition, the electrical contacts in each of the first and second battery receptacles comprise at least one of inductive coupling pins or conductive pins for electrically connecting the first and second detachable batteries to the PMC. The PMC is configured to maintain the computing circuitry of the wearable electronic device powered and operational when one of the first detachable battery or the second detachable battery is removed while the other remains connected.

Further, the PMC is preferably configured to operate in a battery lifespan extending mode that draws power from the first detachable battery and the second detachable battery alternately to achieve uniform depletion. Each of the first detachable battery and the second detachable battery preferably includes monitoring circuitry that tracks charge cycles and communicates with the PMC over a digital communication protocol.

The system preferably includes a backup power source electrically connected to the PMC, which backup power source comprises a capacitor or an internal battery. The backup power source is configured to provide temporary power and maintain the computing circuitry of the wearable electronic device powered and operational when both of the first detachable battery and the second detachable battery are removed. The wearable electronic device preferably comprises smart glasses and the device housing comprises an eyeglass frame having a pair of temple arms. The first battery receptacle and the second battery receptacle are each disposed on one of the pair of temple arms, with the electrical contacts and the magnetic connectors disposed in tips of the temple arms. The magnetic connectors comprise permanent magnetic surfaces configured to provide sufficient holding force to secure the first detachable battery and the second detachable battery during normal use while permitting manual removal.

In a still further embodiment, a smart glasses system is contemplated comprising an eyeglass frame having a pair of temples. Computing circuitry including at least one processor is disposed within the eyeglass frame. First and second detachable battery units, each being configured to attach to a respective temple behind a user's ear. A power management circuit (PMC) is disposed within the eyeglass frame and electrically connected to the computing circuitry. Magnetic attachment elements are configured to secure the first and second detachable battery units to the respective temples. Electrical connection elements comprising pogo pins or inductive coupling tips are configured to electrically connect the detachable battery units to the PMC. A backup capacitor is electrically connected to the PMC and configured to provide temporary power during battery replacement. The PMC is programmed to selectively draw power from the first and second detachable battery units based on their respective charge levels and cycle counts to optimize battery lifespan.

In yet a further embodiment, a smart glasses battery system is contemplated comprising a device housing comprising an eyeglass frame and a pair of temple arms. Computing circuitry including at least one processor is disposed within the device housing, with a first battery receptacle and a second battery receptacle disposed on a respective temple tip on one or the other of the pair of temple arms. Each of the first battery receptacle and the second battery receptacle are configured for connection to a first detachable battery and a second detachable battery. A power management circuit (PMC) is disposed in the device housing and electrically connected to the computing circuitry, the first battery receptacle, and the second battery receptacle.

Magnetic or mechanical connectors are included in the first battery receptacle and the second battery receptacle, such connectors configured to secure the first detachable battery and the second detachable battery to the respective temple tips. Electrical connectors are also included in the first battery receptacle and the second battery receptacle comprising at least one of pogo pins or coupling pins configured to electrically connect the first detachable battery and the second detachable battery to the PMC. A backup power source is electrically connected to the PMC and configured to provide temporary power during replacement of one or both of the first and second detachable batteries. The PMC is preferably programmed to selectively draw power from the first detachable battery and the second detachable battery based on their respective charge levels and cycle counts to optimize battery lifespan.

The PMC may also be programmed to recommend battery swapping patterns based on tracked usage cycles and charge levels of the first detachable battery and the second detachable battery. The PMC is preferably configured to charge one of the first detachable battery and the second detachable battery from the other when charge levels differ by more than a predetermined threshold. The computing circuitry preferably includes display elements, and the computing circuitry remains operational with display functionality during replacement of one or both of the first detachable battery and the second detachable battery.

Other features and advantages of the present invention will become apparent from the following more detailed description, taken in conjunction with the accompanying drawings, which illustrate, by way of example, the principles of the invention.

### BRIEF DESCRIPTION OF THE FIGURES

These and other features and advantages of the present invention will become appreciated, as the same becomes better understood with reference to the specification, claims and drawings herein:

FIG. 1 is a front perspective view of an embodiment of a personal computing device, namely smart glasses, according to the present invention.

FIG. 2 is a rear perspective view of the embodiment of the smart glasses of FIG. 1.

FIG. 3 is a close-up view of an embodiment of a battery and battery receptacle on a tip of a temple arm of smart glasses according to the present invention.

FIG. 3A is a reverse=angle view of the embodiment of FIG. 3.

FIG. 4 is a rear perspective view of an alternate embodiment of a battery and battery receptacle on a tip of a temple arm of smart glasses according to the present invention;

FIG. 5 is a close-up view of a tip of a temple arm of the embodiment of FIG. 4;

FIG. 5A is a reverse-angle close up view of an alternate embodiment of the tip of a temple arm of the embodiment of FIG. 5; and

FIG. 6 is a front perspective view of smart glasses according to the present invention, including a circle close-up call-out to a hinge and camera.

### DETAILED DESCRIPTION

The invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

It will be understood that when an element is referred to as being “on” another element, it can be directly on the other element or intervening elements may be present there between. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section.

As used herein, the singular forms “a,” “an,” and “the,” are intended to include the plural forms as well, unless the context clearly indicates otherwise. It will be further understood that the terms “comprises” and/or “comprising,” “includes” and/or “including,” and “have” and/or “having,” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom,” and “upper” or “top,” and “inner” or “outer,” may be used herein to describe one element's relationship to another elements as illustrated in the Figures. It will be understood that relative terms are intended to encompass different orientations of the device in addition to the orientation depicted in the Figures.

Unless otherwise defined, all terms used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments of the present invention are described herein with reference to idealized embodiments of the present invention. As such, variations from the shapes and configurations of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing.

The invention described herein is primarily concerned with the power supply and management used in handheld and wearable electronic devices such as smart phones, smart glasses and similar wearable technology. While the following detailed description focuses on embodiments of the inventive power system of smart glasses, it is to be understood and appreciated that the same principles of power supply, management, and replacement will apply to all types of personal computing devices, including handheld and wearable devices, including but not limited to smart phones, tables, watches, and glasses. This specification is not necessarily concerned with the function and operation of the wearable devices beyond the power supply and management thereof. Features such as display, audio/video, data communication, and control of such devices are intended to conform to the current state of the art of such features, or as such state of the art may develop in the future.

Therefore, the present invention is directed to a power supply system or apparatus for wearable electronic devices, such as smart glasses. Further, the present invention is concerned with a wearable electronic device, such as smart glasses, wherein a power supply system or apparatus provides one or more batteries that are selectively removable from the wearable electronic device in a manner where the device is continuously powered and/or usable, including during recharging, replacement, or swapping of one or more of the batteries.

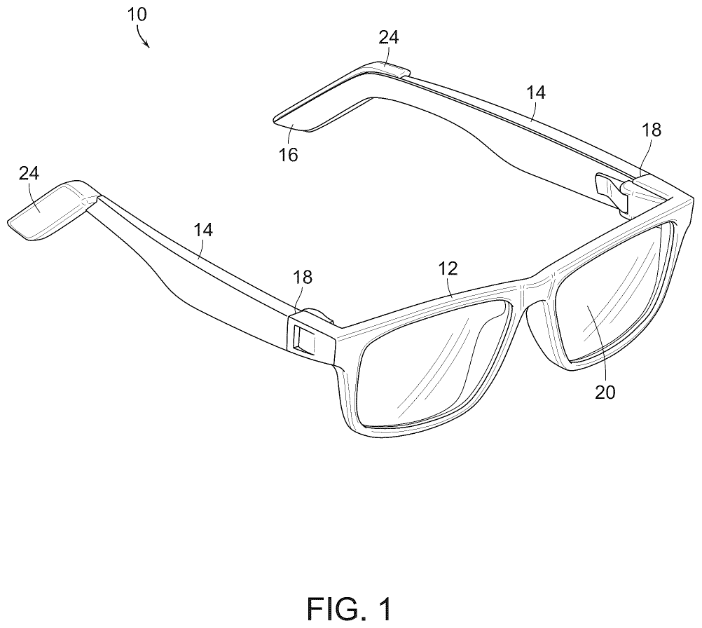

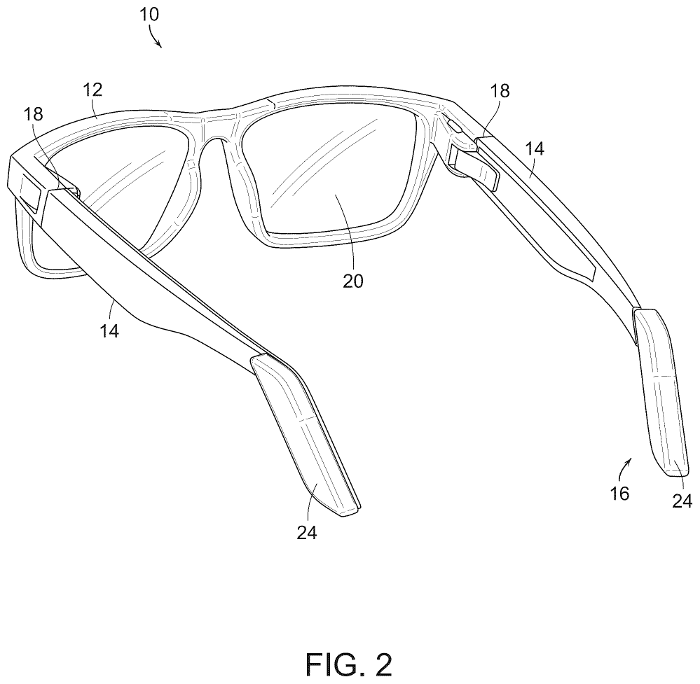

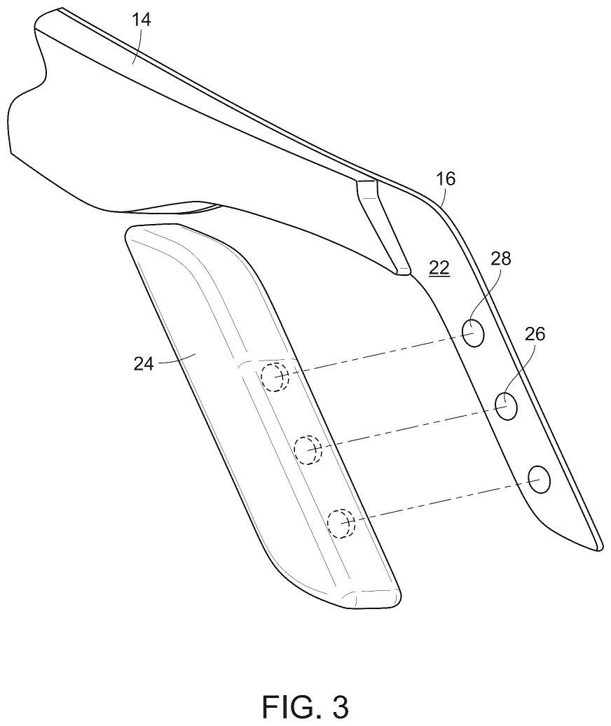

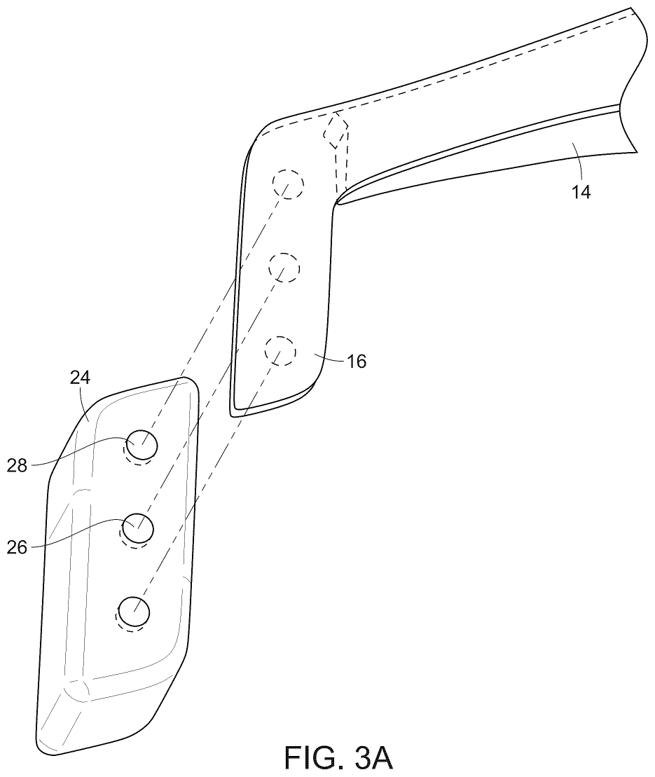

A particular embodiment of the present invention in the form of smart glasses 10 is shown in FIGS. 1 and 2. Such smart glasses 10 have the typical features of a frame 12, temples or temple arms 14, temple tips 16, hinges 18, and lenses 20. In this embodiment, the temple tips 16 are preferably configured with battery receptacles 22 which receive batteries 24. FIGS. 3 and 3A illustrate a close-up view of such temple tips 16, wherein a battery 24 is shown in spaced relation to a battery receptacle 22. In this particular embodiment, the battery receptacle 22 and battery 24 are shown with schematic representations of electrical contacts 26 and physical contacts 28—such contacts being in one or more form of mechanical, magnetic, inductive, conductive, or other known form of connection or attraction to achieve electrical and physical connection.

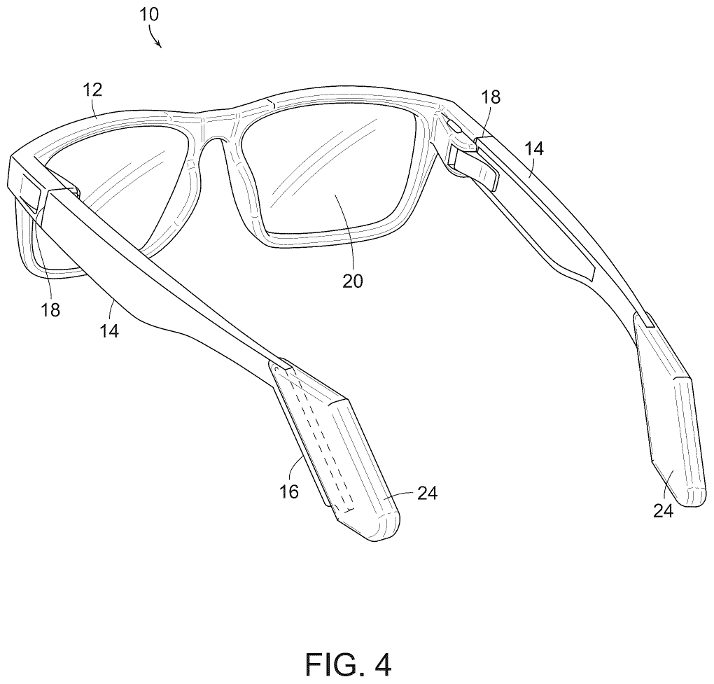

In FIGS. 3 and 3a, the battery 24 engages and remains on the receptable 22 from a lateral side, e.g., an inside or outside surface of the temple tip 16 extending toward or away from a center line of the frame 12. There is preferably a receptacle 22 and a corresponding battery 24 included on the temple tip 16 of each temple arm 14. FIG. 4 illustrates an alternate embodiment where the batteries 24 engage with the battery receptacles 22 from an end, e.g., an end surface of the temple tips 16 adding length to the temple arms 14. In the embodiment of FIG. 4, the form of the electrical contacts 26 and physical contacts 28 are shown in detail, but understood to comprise one of the foregoing described forms.

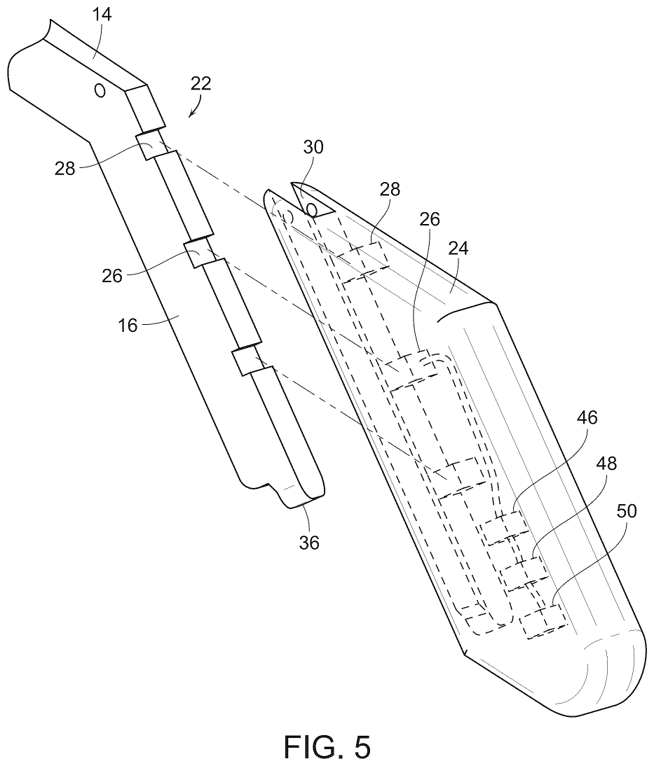

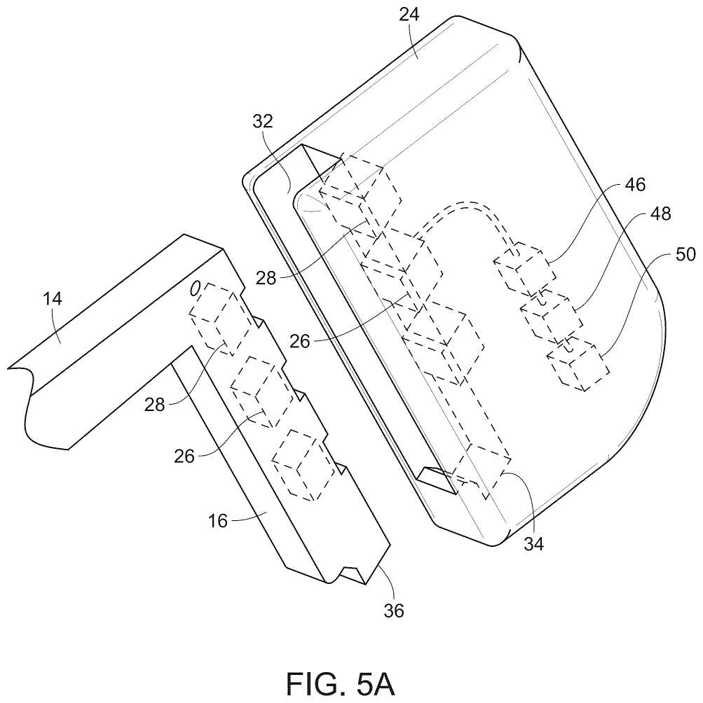

FIGS. 5 and 5A illustrate close-up views of alternate embodiments of the electrical contacts 26 and physical contacts 28. In one embodiment, shown in FIG. 5, the extreme ends of the temple tips 16 are configured to be inserted in a slot 30 on the battery 24. The slot 30 has a depth that is configured to accept a sufficient portion of the temple tip 16 to provide stability to the connection. Corresponding elements of the electrical contacts 26 and physical contacts 28 are shown on the end of the temple tip 16 and in the slot 30 of the battery 24. FIG. 5A illustrates an alternate embodiment where the slot 30 is replaced by an open groove 32 wherein similar corresponding elements of the electrical contacts 26 and physical contacts 28 are shown on the end of the temple tip 16 and in the open groove 32 of the battery 24. In each embodiment, the corresponding electrical contacts 26 and physical contacts 28 have mating extensions and recesses, that increase surface contact for improved electrical and physical connection. In addition, the slot 30 and open groove 32 in each embodiment includes a notch 34 configured to receive a corresponding tab 36 on the temple tip 16 to provide additional securement and attachment.

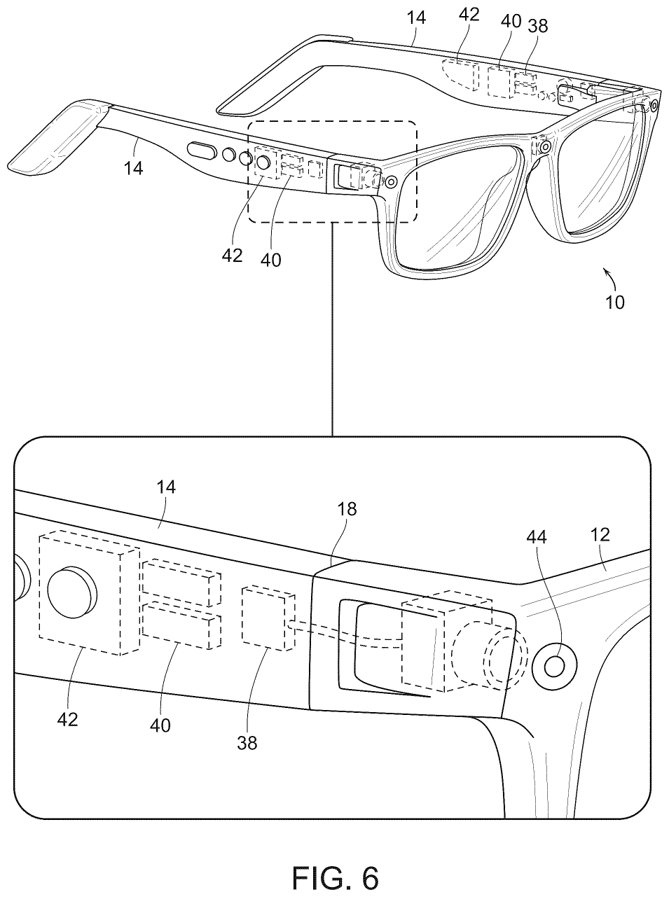

FIGS. 6 and 6A illustrate a partially transparent view of the smart glasses 10 showing computing circuity 38, a power management circuit (PMC) 40, a back-up power source 42 and other elements contained within the frame 12 and/or temple arms 14. One such other element might include a camera 44, preferably disposed in the hinge 18 or front surface of the frame 12, adjacent to a lens 20. Although not shown in complete detail, it is understood that the computing circuity 38, power management circuit (PMC) 40, back-up power source 42 and other elements are internally connected by conductive wiring or similar technology, including connecting the PMC 40 to the electrical contacts 26 of the receptacles 22 on the temple tips 16.

The inventive power supply system or apparatus is configured such that the manner in which the power stored in one or batteries 24 is selectively depleted so as to optimize battery life and so to maintain sufficient charge for steady reliable operation. The system optimizes battery life by a number of methods, including but not limited to by minimizing the overall number of depleting/recharging cycles for a particular battery, as well as fully depleting a single battery of charge before recharging, minimizing frequent drain on a second battery. The system maintains sufficient charge for steady reliable operation by maintaining a minimum charge in one or more batteries 24 before fully depleting one battery 24, as well as by transferring a portion of a higher charge from one battery 24 to another battery 24 with a lower charge.

Two of the primary purposes of the present invention is the preservation of battery lifetime and the maintenance of continuous operation of the particular computing device. There can be multiple batteries 24 connected to a given wearable electronic device 10 at any given time. Each of such multiple batteries 24 can have varying voltages depending upon how much charge each battery has at a given moment and its number of charge cycles, i.e., how many times a battery has been charged and discharged. Each battery 24 may be connected to its own small-printed circuit board (PCB) 46 with a microcontroller and “fuel gauge” integrated circuit (IC) 48 that tracks a particular battery's cycles by saving to EEPROM or other on-board memory storage 50. This configuration provides data to the power management circuit (PMC) 40 over I2C (or similar suitable digital connection) and allows for recommendations to the user. For example, if a user repeatedly changes only one battery, i.e., the right battery, when it gets low, but rarely changes the other battery, the PMC 40 of the device 10 may recommend the user to swap left and right batteries to better balance the batteries for uniform charge and cycles, i.e., wear and tear.

The PMC may be set into a “battery lifespan extending” mode, in multiple ways. The PCB and IC “fuel gauge” may automatically set such mode. Alternatively, a main device processor may command a PMC to set such mode. Such a main device processor may be part of a separate IC from the PMC - or the main device processor can itself be the PMC in a unified implementation. Further, the user may manually set such operation mode in the software. Such a “battery lifespan extending” mode would draw power from each battery alternately to deplete them both more uniformly, switching periodically or drawing in parallel. Such mode would also prevent depleting one battery below a pre-determined threshold until all available power from the other battery power is depleted. For example, assuming both batteries start at 100%, the system may be configured to use both batteries down to 25% before continuing to use one battery one down to 0% and then switching to the other battery.

The system may also XXX be configured so as to charge one battery from the other battery. For example, if one battery was at or near 0% available capacity, and the user puts on a second battery with more than 0% available capacity, preferably closer to 100%, the system could transfer charge the first battery up to a threshold (25% for example) while also powering the device from the second battery. This configuration will help keep batteries in a state which is safe for storage and extends battery lifespan.

The PMC may include a controller such as a field programmable gate array (FPGA) or microcontroller/microprocessor. An FPGA may contain proprietary VHDL-encoded logic (virtual hardware description language), and the microcontroller may contain proprietary firmware. Such VHDL-encoded logic and/or firmware would be configured to create the operating parameters described above.

Although several embodiments have been described in detail for purposes of illustration, various modifications may be made without departing from the scope and spirit of the invention.

1. A personal computing device battery system comprising:
a device housing configured to be worn or held by a user;
computing circuitry disposed within the device housing;
at least one battery receptacle on the device housing, the at least one battery receptacle having electrical contacts configured for connection to a detachable battery;
a power management circuit in the device housing, the power management circuit electrically connected to the computing circuitry and the electrical contacts in the at least one battery receptacle; and
a backup power source in the device housing and electrically connected to the power management circuit, wherein the backup power source is configured to temporarily provide power to the computing circuitry when no detachable battery is connected to the electrical contacts in the at least one battery receptacle; and
wherein the backup power source is configured to maintain the computing circuitry of the personal computing device powered and operational during removal and replacement of a detachable battery from the at least one battery receptacle.

2. The personal computing device battery system of claim 1, wherein the at least one battery receptacle comprises a first battery receptacle and a second battery receptacle, the first battery receptacle configured to receive a first detachable battery and the second battery receptacle configured to receive a second detachable battery.

3. The personal computing device battery system of claim 2, wherein the power management circuit is configured to selectively draw power from the first detachable battery and the second detachable battery based on relative battery condition of each of the first detachable battery and the second detachable battery.

4. The personal computing device battery system of claim 3, wherein the power management circuit is programmed to draw power from both the first detachable battery and the second detachable battery alternately so as to deplete the first detachable battery and the second detachable battery uniformly.

5. The personal computing device battery system of claim 3, wherein the power management circuit is configured to prevent depleting one of the first detachable battery or the second detachable battery below a predetermined threshold until available power from another detachable battery is substantially depleted.

6. The personal computing device battery system of claim 2, wherein the power management circuit is configured to transfer charge from the first detachable battery to the second detachable battery when a charge level of the second detachable battery falls below a predetermined threshold.

7. The personal computing device battery system of claim 1, wherein each of the first detachable battery and the second detachable battery each include a printed circuit board with a microcontroller and a fuel gauge integrated circuit that tracks battery cycles and communicates battery condition to the power management circuit.

8. The personal computing device battery system of claim 7, wherein the fuel gauge integrated circuit saves cycle data to EEPROM memory and provides recommendations for battery usage patterns.

9. The personal computing device battery system of claim 1, wherein the backup power source comprises a capacitor configured to maintain power to the computing circuitry for a duration sufficient to complete replacement of a detachable battery.

10. The personal computing device battery system of claim 1, wherein the electrical contacts comprise a magnetic coupling for physical connection and at least one of inductive couplings or spring-loaded conductive pins for electrical connection.

11. The personal computing device battery system of claim 1, wherein the power management circuit comprises at least one of a field programmable gate array (FPGA) or a microcontroller containing firmware configured to manage power distribution from one or more detachable batteries.

12. A wearable electronic device battery system comprising:
a device housing configured to be worn on a user's body;
computing circuitry disposed within the device housing;
a first battery receptacle and a second battery receptacle, both disposed on the device housing, each of the first battery receptacle and the second battery receptacle having electrical contacts configured for connection to a first detachable battery and a second detachable battery respectively;
a power management circuit electrically connected to the computing circuitry and configured to receive power from one of the first detachable battery or the second detachable battery when connected to the first battery receptacle or the second battery receptacle; and
magnetic or mechanical connectors in the first battery receptacle and the second battery receptacle configured to secure the first detachable battery and the second detachable battery respectively;
wherein the electrical contacts in each of the first battery receptacle and the second battery receptacle comprise at least one of inductive coupling pins or conductive pins for electrically connecting the first detachable battery and the second detachable battery to the power management circuit;
wherein the power management circuit is configured to maintain the computing circuitry of the wearable electronic device powered and operational when one of the first detachable battery or the second detachable battery is removed while the other remains connected.

13. The wearable electronic device battery system of claim 12, wherein the power management circuit is configured to operate in a battery lifespan extending mode that draws power from the first detachable battery and the second detachable battery alternately to achieve uniform depletion.

14. The wearable electronic device battery system of claim 12, wherein each of the first detachable battery and the second detachable battery includes monitoring circuitry that tracks charge cycles and communicates with the power management circuit over a digital communication protocol.

15. The wearable electronic device battery system of claim 12, further comprising a backup power source electrically connected to the power management circuit, the backup power source comprising a capacitor or an internal battery, wherein the backup power source is configured to provide temporary power and maintain the computing circuitry of the wearable electronic device powered and operational when both of the first detachable battery and the second detachable battery are removed.

16. The wearable electronic device battery system of claim 12, wherein the wearable electronic device comprises smart glasses and the device housing comprises an eyeglass frame having a pair of temple arms, wherein the first battery receptacle and the second battery receptacle are each disposed on one of the pair of temple arms, with the electrical contacts and the magnetic connectors disposed in tips of the temple arms, wherein magnetic connectors comprise permanent magnetic surfaces configured to provide sufficient holding force to secure the first detachable battery and the second detachable battery during normal use while permitting manual removal.

17. A smart glasses battery system comprising:
a device housing comprising an eyeglass frame and a pair of temple arms;
computing circuitry including at least one processor disposed within the device housing;
a first battery receptacle and a second battery receptacle disposed on a respective temple tip on one or the other of the pair of temple arms, wherein each of the first battery receptacle and the second battery receptacle are configured for connection to a first detachable battery and a second detachable battery respectively;
a power management circuit disposed in the device housing and electrically connected to the computing circuitry, the first battery receptacle, and the second battery receptacle;
magnetic of mechanical connectors in the first battery receptacle and the second battery receptacle configured to secure the first detachable battery and the second detachable battery to the respective temple tips;
electrical connectors in the first battery receptacle and the second battery receptacle comprising at least one of pogo pins or coupling pins configured to electrically connect the first detachable battery and the second detachable battery to the power management circuit; and
a backup power source electrically connected to the power management circuit and configured to provide temporary power during replacement of one or both of the first detachable battery and the second detachable battery;
wherein the power management circuit is programmed to selectively draw power from the first detachable battery and the second detachable battery based on their respective charge levels and cycle counts to optimize battery lifespan.

18. The smart classes battery system of claim 17, wherein the power management circuit is programmed to recommend battery swapping patterns based on tracked usage cycles and charge levels of the first detachable battery and the second detachable battery.

19. The smart glasses battery system of claim 17, wherein the power management circuit is configured to charge one of the first detachable battery and the second detachable battery from the other of the first detachable battery and the second detachable battery when charge levels differ by more than a predetermined threshold.

20. The smart glasses battery system of claim 17, wherein the computing circuitry includes display elements, and the comprising circuitry remains operational with display functionality during replacement of one or both of the first detachable battery and the second detachable battery.
